(19) United States
(12) Patent Application Publication
(10) Pub. No.: US 2020/0104973 A1
(43) Pub. Date: Apr. 2, 2020

(54) METHODS AND APPARATUS FOR FRAME COMPOSITION ALIGNMENT

(71) Applicant: QUALCOMM Incorporated, San Diego, CA (US)

(72) Inventors: Bin ZHANG, Shanghai (CN); Yanshan WEN, Shanghai (CN); Zhibin WANG, Shanghai (CN)

(21) Appl. No.: 16/289,303

(22) Filed: Feb. 28, 2019

(30) Foreign Application Priority Data
Sep. 28, 2018 (CN) PCT/CN2018/108435

(51) Int. Cl. G06T 1/60; G06T 1/20

(52) U.S. Cl. CPC G06T 1/60; G06T 1/20

(57) ABSTRACT

The present disclosure relates to methods and apparatus of operation of a frame composer. In some aspects, the apparatus can determine a target frame latency time. The apparatus can also determine whether a current frame latency time of a current frame is less than the target frame latency time. Additionally, the apparatus can consume the current frame at a first VSYNC time if the current frame latency time is greater than or equal to the target frame latency time. The apparatus can also determine the amount of frames in a buffer queue if the current frame latency time is less than the target frame latency time. Further, the apparatus can determine whether the amount of frames in the buffer queue is greater than one. The apparatus can also consume the current frame at the first VSYNC time if the amount of frames in the buffer queue is greater than one.

### CROSS REFERENCE TO RELATED APPLICATION(S)

This application claims the benefit of International Application No. PCT/CN2018/108435, entitled “FRAME COMPOSITION ALIGNMENT TO TARGET FRAME RATE FOR JANKS REDUCTION” and filed on Sep. 28, 2018, which is expressly incorporated by reference herein in its entirety.

### TECHNICAL FIELD

The present disclosure relates generally to processing systems and, more particularly, to one or more techniques for graphics processing.

### INTRODUCTION

Computing devices often utilize a video processor or graphics processing unit (GPU) to accelerate the rendering of video or graphical data for display. Such computing devices may include, for example, computer workstations, mobile phones such as so-called smartphones, embedded systems, personal computers, tablet computers, and video game consoles. Video processors or GPUs execute a video or graphics processing pipeline that includes a plurality of processing stages that operate together to execute video or graphics processing commands and output a frame. A central processing unit (CPU) may control the operation of the video processor or GPU by issuing one or more graphics processing commands to the video processor or GPU. Modern day CPUs are typically capable of concurrently executing multiple applications, each of which may need to utilize the video processor or GPU during execution. A device that provides content for visual presentation on a display generally includes a video processor or GPU.

Typically, a video processor or GPU of a device is configured to perform every process in a video or graphics processing pipeline. However, with the advent of wireless communication and the streaming of content, e.g., game content or any other content that is rendered using a GPU, there has developed a need for improved video or graphics processing.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a frame composer. In some aspects, the apparatus can determine a target frame latency time. The apparatus can also determine whether a current frame latency time of a current frame is less than the target frame latency time. Additionally, the apparatus can consume the current frame at a first vertical synchronization (VSYNC) time if the current frame latency time is greater than or equal to the target frame latency time. The apparatus can also determine the amount of frames in a buffer queue if the current frame latency time is less than the target frame latency time. Further, the apparatus can determine whether the amount of frames in the buffer queue is greater than one. In some aspects, the apparatus can consume the current frame at the first VSYNC time if the amount of frames in the buffer queue is greater than one. In other aspects, the apparatus can consume the current frame at a second VSYNC time if the amount of frames in the buffer queue is less than or equal to one, where the second VSYNC time is after the first VSYNC time.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation and coding system in accordance with one or more techniques of this disclosure.

FIG. 2 illustrates an example timing diagram in accordance with one or more techniques of this disclosure.

FIG. 3 illustrates an example timing diagram in accordance with one or more techniques of this disclosure.

FIG. 4 illustrates an example structure in accordance with one or more techniques of this disclosure.

FIG. 5 illustrates an example structure in accordance with one or more techniques of this disclosure.

FIG. 6 illustrates an example timing diagram in accordance with one or more techniques of this disclosure.

FIG. 7 illustrates an example timing diagram in accordance with one or more techniques of this disclosure.

FIG. 8 illustrates an example timing diagram in accordance with one or more techniques of this disclosure.

FIG. 9 illustrates an example flowchart of an example method in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include video processors, microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application (i.e., software) being configured to perform one or more functions. In such examples, the application may be stored on a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a graphics processing pipeline across multiple devices, improving the coding of video or graphical content, and/or reducing the load of a processing unit (i.e., any processing unit configured to perform one or more techniques described herein, such as a graphics processing unit (GPU)). For example, this disclosure describes techniques for graphics processing in communication systems. Other example benefits are described throughout this disclosure.

As used herein, the term “coder” may generically refer to an encoder and/or decoder. For example, reference to a “content coder” may include reference to a content encoder and/or a content decoder. Similarly, as used herein, the term “coding” may generically refer to encoding and/or decoding. As used herein, the terms “encode” and “compress” may be used interchangeably. Similarly, the terms “decode” and “decompress” may be used interchangeably.

As used herein, instances of the term “content” may refer to the term “video,” “graphical content,” “image,” and vice versa. This is true regardless of whether the terms are being used as an adjective, noun, or other parts of speech. For example, reference to a “content coder” may include reference to a “video coder,” “graphical content coder,” or “image coder,”; and reference to a “video coder,” “graphical content coder,” or “image coder” may include reference to a “content coder.” As another example, reference to a processing unit providing content to a content coder may include reference to the processing unit providing graphical content to a video encoder. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

As used herein, instances of the term “content” may refer to graphical content or display content. In some examples, as used herein, the term “graphical content” may refer to a content generated by a processing unit configured to perform graphics processing. For example, the term “graphical content” may refer to content generated by one or more processes of a graphics processing pipeline. In some examples, as used herein, the term “graphical content” may refer to content generated by a graphics processing unit. In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling (e.g., upscaling or downscaling) on a frame. In some examples, a frame may refer to a layer. In other examples, a frame may refer to two or more layers that have already been blended together to form the frame (i.e., the frame includes two or more layers, and the frame that includes two or more layers may subsequently be blended).

As referenced herein, a first component (e.g., a processing unit) may provide content, such as graphical content, to a second component (e.g., a content coder). In some examples, the first component may provide content to the second component by storing the content in a memory accessible to the second component. In such examples, the second component may be configured to read the content stored in the memory by the first component. In other examples, the first component may provide content to the second component without any intermediary components (e.g., without memory or another component). In such examples, the first component may be described as providing content directly to the second component. For example, the first component may output the content to the second component, and the second component may be configured to store the content received from the first component in a memory, such as a buffer.

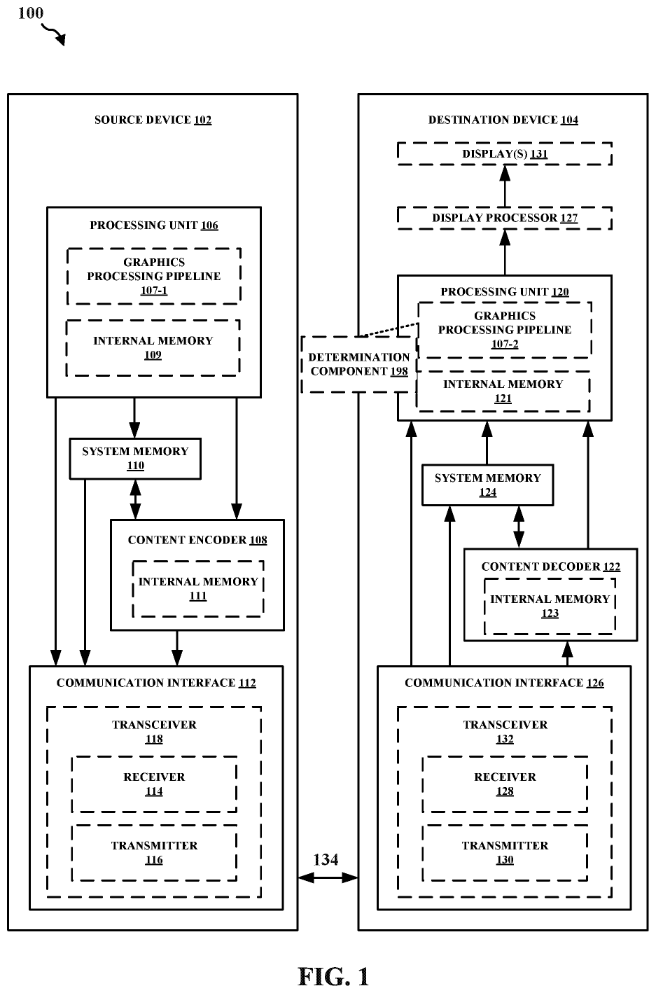

FIG. 1 is a block diagram that illustrates an example content generation and coding system 100 configured to implement one or more techniques of this disclosure. The content generation and coding system 100 includes a source device 102 and a destination device 104. In accordance with the techniques described herein, the source device 102 may be configured to encode, using the content encoder 108, graphical content generated by the processing unit 106 prior to transmission to the destination device 104. The content encoder 108 may be configured to output a bitstream having a bit rate. The processing unit 106 may be configured to control and/or influence the bit rate of the content encoder 108 based on how the processing unit 106 generates graphical content.

The source device 102 may include one or more components (or circuits) for performing various functions described herein. The destination device 104 may include one or more components (or circuits) for performing various functions described herein. In some examples, one or more components of the source device 102 may be components of a SOC. Similarly, in some examples, one or more components of the destination device 104 may be components of an SOC.

The source device 102 may include one or more components configured to perform one or more techniques of this disclosure. In the example shown, the source device 102 may include a processing unit 106, a content encoder 108, a system memory 110, and a communication interface 112. The processing unit 106 may include an internal memory 109. The processing unit 106 may be configured to perform graphics processing, such as in a graphics processing pipeline 107-1. The content encoder 108 may include an internal memory 111.

Memory external to the processing unit 106 and the content encoder 108, such as system memory 110, may be accessible to the processing unit 106 and the content encoder 108. For example, the processing unit 106 and the content encoder 108 may be configured to read from and/or write to external memory, such as the system memory 110. The processing unit 106 and the content encoder 108 may be communicatively coupled to the system memory 110 over a bus. In some examples, the processing unit 106 and the content encoder 108 may be communicatively coupled to each other over the bus or a different connection.

The content encoder 108 may be configured to receive graphical content from any source, such as the system memory 110 and/or the processing unit 106. The system memory 110 may be configured to store graphical content generated by the processing unit 106. For example, the processing unit 106 may be configured to store graphical content in the system memory 110. The content encoder 108 may be configured to receive graphical content (e.g., from the system memory 110 and/or the processing unit 106) in the form of pixel data. Otherwise described, the content encoder 108 may be configured to receive pixel data of graphical content produced by the processing unit 106. For example, the content encoder 108 may be configured to receive a value for each component (e.g., each color component) of one or more pixels of graphical content. As an example, a pixel in the red (R), green (G), blue (B) (RGB) color space may include a first value for the red component, a second value for the green component, and a third value for the blue component.

The internal memory 109, the system memory 110, and/or the internal memory 111 may include one or more volatile or non-volatile memories or storage devices. In some examples, internal memory 109, the system memory 110, and/or the internal memory 111 may include RAM, static RAM (SRAM), dynamic RAM (DRAM), erasable programmable ROM (EPROM), electrically erasable programmable ROM (EEPROM), Flash memory, a magnetic data media or an optical storage media, or any other type of memory.

The internal memory 109, the system memory 110, and/or the internal memory 111 may be a non-transitory storage medium according to some examples. The term “non-transitory”may indicate that the storage medium is not embodied in a carrier wave or a propagated signal. However, the term “non-transitory” should not be interpreted to mean that internal memory 109, the system memory 110, and/or the internal memory 111 is non-movable or that its contents are static. As one example, the system memory 110 may be removed from the source device 102 and moved to another device. As another example, the system memory 110 may not be removable from the source device 102.

The processing unit 106 may be a central processing unit (CPU), a graphics processing unit (GPU), a general purpose GPU (GPGPU), or any other processing unit that may be configured to perform graphics processing. In some examples, the processing unit 106 may be integrated into a motherboard of the source device 102. In some examples, the processing unit 106 may be may be present on a graphics card that is installed in a port in a motherboard of the source device 102, or may be otherwise incorporated within a peripheral device configured to interoperate with the source device 102.

The processing unit 106 may include one or more processors, such as one or more microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 106 may store instructions for the software in a suitable, non-transitory computer-readable storage medium (e.g., internal memory 109), and may execute the instructions in hardware using one or more processors to perform the techniques of this disclosure. Any of the foregoing (including hardware, software, a combination of hardware and software, etc.) may be considered to be one or more processors.

The content encoder 108 may be any processing unit configured to perform content encoding. In some examples, the content encoder 108 may be integrated into a motherboard of the source device 102. The content encoder 108 may include one or more processors, such as one or more video processors, microprocessors, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the content encoder 108 may store instructions for the software in a suitable, non-transitory computer-readable storage medium (e.g., internal memory 111), and may execute the instructions in hardware using one or more processors to perform the techniques of this disclosure. Any of the foregoing (including hardware, software, a combination of hardware and software, etc.) may be considered to be one or more processors.

The communication interface 112 may include a receiver 114 and a transmitter 116. The receiver 114 may be configured to perform any receiving function described herein with respect to the source device 102. For example, the receiver 114 may be configured to receive information from the destination device 104, which may include a request for content. In some examples, in response to receiving the request for content, the source device 102 may be configured to perform one or more techniques described herein, such as produce or otherwise generate graphical content for delivery to the destination device 104. The transmitter 116 may be configured to perform any transmitting function described herein with respect to the source device 102. For example, the transmitter 116 may be configured to transmit encoded content to the destination device 104, such as encoded graphical content produced by the processing unit 106 and the content encoder 108 (i.e., the graphical content is produced by the processing unit 106, which the content encoder 108 receives as input to produce or otherwise generate the encoded graphical content). The receiver 114 and the transmitter 116 may be combined into a transceiver 118. In such examples, the transceiver 118 may be configured to perform any receiving function and/or transmitting function described herein with respect to the source device 102.

The destination device 104 may include one or more components configured to perform one or more techniques of this disclosure. In the example shown, the destination device 104 may include a processing unit 120, a content decoder 122, a system memory 124, a communication interface 126, and one or more displays 131. Reference to the display 131 may refer to the one or more displays 131. For example, the display 131 may include a single display or a plurality of displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon.

The processing unit 120 may include an internal memory 121. The processing unit 120 may be configured to perform video or graphics processing, such as in a graphics processing pipeline 107-2. The content decoder 122 may include an internal memory 123. In some examples, the destination device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display content that was generated using decoded content. For example, the display processor 127 may be configured to process one or more frames generated by the processing unit 120, where the one or more frames are generated by the processing unit 120 by using decoded content that was derived from encoded content received from the source device 102. In turn the display processor 127 may be configured to perform display processing on the one or more frames generated by the processing unit 120. The one or more displays 131 may be configured to display or otherwise present frames processed by the display processor 127. In some examples, the one or more display devices may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content decoder 122, such as system memory 124, may be accessible to the processing unit 120 and the content decoder 122. For example, the processing unit 120 and the content decoder 122 may be configured to read from and/or write to external memory, such as the system memory 124. The processing unit 120 and the content decoder 122 may be communicatively coupled to the system memory 124 over a bus. In some examples, the processing unit 120 and the content decoder 122 may be communicatively coupled to each other over the bus or a different connection.

The content decoder 122 may be configured to receive graphical content from any source, such as the system memory 124 and/or the communication interface 126. The system memory 124 may be configured to store received encoded graphical content, such as encoded graphical content received from the source device 102. The content decoder 122 may be configured to receive encoded graphical content (e.g., from the system memory 124 and/or the communication interface 126) in the form of encoded pixel data. The content decoder 122 may be configured to decode encoded graphical content.

The internal memory 121, the system memory 124, and/or the internal memory 123 may include one or more volatile or non-volatile memories or storage devices. In some examples, internal memory 121, the system memory 124, and/or the internal memory 123 may include RAM, SRAM, DRAM, erasable programmable ROM (EPROM), electrically erasable programmable ROM (EEPROM), Flash memory, a magnetic data media or an optical storage media, or any other type of memory.

The internal memory 121, the system memory 124, and/or the internal memory 123 may be a non-transitory storage medium according to some examples. The term “non-transitory” may indicate that the storage medium is not embodied in a carrier wave or a propagated signal. However, the term “non-transitory” should not be interpreted to mean that internal memory 121, the system memory 124, and/or the internal memory 123 is non-movable or that its contents are static. As one example, the system memory 124 may be removed from the destination device 104 and moved to another device. As another example, the system memory 124 may not be removable from the destination device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the destination device 104. In some examples, the processing unit 120 may be may be present on a graphics card that is installed in a port in a motherboard of the destination device 104, or may be otherwise incorporated within a peripheral device configured to interoperate with the destination device 104.

The processing unit 120 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium (e.g., internal memory 121), and may execute the instructions in hardware using one or more processors to perform the techniques of this disclosure. Any of the foregoing (including hardware, software, a combination of hardware and software, etc.) may be considered to be one or more processors.

The content decoder 122 may be any processing unit configured to perform content decoding. In some examples, the content decoder 122 may be integrated into a motherboard of the destination device 104. The content decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content decoder 122 may store instructions for the software in a suitable, non-transitory computer-readable storage medium (e.g., internal memory 123), and may execute the instructions in hardware using one or more processors to perform the techniques of this disclosure. Any of the foregoing (including hardware, software, a combination of hardware and software, etc.) may be considered to be one or more processors.

The communication interface 126 may include a receiver 128 and a transmitter 130. The receiver 128 may be configured to perform any receiving function described herein with respect to the destination device 104. For example, the receiver 128 may be configured to receive information from the source device 102, which may include encoded content, such as encoded graphical content produced or otherwise generated by the processing unit 106 and the content encoder 108 of the source device 102 (i.e., the graphical content is produced by the processing unit 106, which the content encoder 108 receives as input to produce or otherwise generate the encoded graphical content). As another example, the receiver 114 may be configured to receive position information from the destination device 104, which may be encoded or unencoded (i.e., not encoded). Additionally, the receiver 128 may be configured to receive position information from the source device 102. In some examples, the destination device 104 may be configured to decode encoded graphical content received from the source device 102 in accordance with the techniques described herein. For example, the content decoder 122 may be configured to decode encoded graphical content to produce or otherwise generate decoded graphical content. The processing unit 120 may be configured to use the decoded graphical content to produce or otherwise generate one or more frames for presentment on the one or more displays 131. The transmitter 130 may be configured to perform any transmitting function described herein with respect to the destination device 104. For example, the transmitter 130 may be configured to transmit information to the source device 102, which may include a request for content. The receiver 128 and the transmitter 130 may be combined into a transceiver 132. In such examples, the transceiver 132 may be configured to perform any receiving function and/or transmitting function described herein with respect to the destination device 104.

The content encoder 108 and the content decoder 122 of content generation and coding system 100 represent examples of computing components (e.g., processing units) that may be configured to perform one or more techniques for encoding content and decoding content in accordance with various examples described in this disclosure, respectively. In some examples, the content encoder 108 and the content decoder 122 may be configured to operate in accordance with a content coding standard, such as a video coding standard, a display stream compression standard, or an image compression standard.

As shown in FIG. 1, the source device 102 may be configured to generate encoded content. Accordingly, the source device 102 may be referred to as a content encoding device or a content encoding apparatus. The destination device 104 may be configured to decode the encoded content generated by source device 102. Accordingly, the destination device 104 may be referred to as a content decoding device or a content decoding apparatus. In some examples, the source device 102 and the destination device 104 may be separate devices, as shown. In other examples, source device 102 and destination device 104 may be on or part of the same computing device. In some instances, a graphics processing pipeline may be distributed between the two devices. For example, a single graphics processing pipeline may include a plurality of video or graphics processes. The graphics processing pipeline 107-1 may include one or more video or graphics processes of the plurality of video or graphics processes. Similarly, graphics processing pipeline 107-2 may include one or more video or graphics processes of the plurality of video or graphics processes. In this regard, the graphics processing pipeline 107-1 concatenated or otherwise followed by the graphics processing pipeline 107-2 may result in a full video or graphics processing pipeline. Otherwise described, the graphics processing pipeline 107-1 may be a partial video or graphics processing pipeline and the graphics processing pipeline 107-2 may be a partial video or graphics processing pipeline that, when combined, result in an improved video or graphics processing pipeline.

Referring again to FIG. 1, in certain aspects, the graphics processing pipeline 107-2 may include a determination component 198 configured to determining a target frame latency time. The determination component 198 can also be configured to determine whether a current frame latency time of a current frame is less than the target frame latency time. The determination component 198 can also be configured to consume the current frame at a first VSYNC time if the current frame latency time is greater than or equal to the target frame latency time. Additionally, the determination component 198 can be configured to determine the amount of frames in a buffer queue if the current frame latency time is less than the target frame latency time. Further, the determination component 198 can be configured to determine whether the amount of frames in the buffer queue is greater than one. In some aspects, the determination component 198 can be configured to consume the current frame at the first VSYNC time if the amount of frames in the buffer queue is greater than one. In other aspects, the determination component 198 can be configured to consume the current frame at a second VSYNC time if the amount of frames in the buffer queue is less than or equal to one, where the second VSYNC time is after the first VSYNC time. By distributing the graphics processing pipeline between the source device 102 and the destination device 104, the destination device may be able to, in some examples, present graphical content that it otherwise would not be able to render or present. Other example benefits are described throughout this disclosure.

As described herein, a device, such as the source device 102 and/or the destination device 104, may refer to any device, apparatus, or system configured to perform one or more techniques described herein. For example, a device may be a server, a base station, user equipment, a client device, a station, an access point, a computer (e.g., a personal computer, a desktop computer, a laptop computer, a tablet computer, a computer workstation, or a mainframe computer), an end product, an apparatus, a phone, a smart phone, a server, a video game platform or console, a handheld device (e.g., a portable video game device or a personal digital assistant (PDA)), a wearable computing device (e.g., a smart watch, an augmented reality device, or a virtual reality device), a non-wearable device, an augmented reality device, a virtual reality device, a display (e.g., display device), a television, a television set-top box, an intermediate network device, a digital media player, a video streaming device, a content streaming device, an in-car computer, any mobile device, any device configured to generate graphical content, or any device configured to perform one or more techniques described herein.

Source device 102 may be configured to communicate with the destination device 104. For example, destination device 104 may be configured to receive encoded content from the source device 102. In some example, the communication coupling between the source device 102 and the destination device 104 is shown as link 134. Link 134 may comprise any type of medium or device capable of moving the encoded content from source device 102 to the destination device 104.

In the example of FIG. 1, link 134 may comprise a communication medium to enable the source device 102 to transmit encoded content to destination device 104 in real-time. The encoded content may be modulated according to a communication standard, such as a wireless communication protocol, and transmitted to destination device 104. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 102 to the destination device 104. In other examples, link 134 may be a point-to-point connection between source device 102 and destination device 104, such as a wired or wireless display link connection (e.g., a high definition multimedia interface (HDMI) link, a DisplayPort link, a Mobile Industry Processor Interface (MIPI) display serial interface (DSI) link, or another link over which encoded content may traverse from the source device 102 to the destination device 104.

In another example, the link 134 may include a storage medium configured to store encoded content generated by the source device 102. In this example, the destination device 104 may be configured to access the storage medium. The storage medium may include a variety of locally-accessed data storage media such as Blu-ray discs, DVDs, CD-ROMs, flash memory, or other suitable digital storage media for storing encoded content.

In another example, the link 134 may include a server or another intermediate storage device configured to store encoded content generated by the source device 102. In this example, the destination device 104 may be configured to access encoded content stored at the server or other intermediate storage device. The server may be a type of server capable of storing encoded content and transmitting the encoded content to the destination device 104.

Devices described herein may be configured to communicate with each other, such as the source device 102 and the destination device 104. Communication may include the transmission and/or reception of information. The information may be carried in one or more messages. As an example, a first device in communication with a second device may be described as being communicatively coupled to or otherwise with the second device. For example, a client device and a server may be communicatively coupled. As another example, a server may be communicatively coupled to a plurality of client devices. As another example, any device described herein configured to perform one or more techniques of this disclosure may be communicatively coupled to one or more other devices configured to perform one or more techniques of this disclosure. In some examples, when communicatively coupled, two devices may be actively transmitting or receiving information, or may be configured to transmit or receive information. If not communicatively coupled, any two devices may be configured to communicatively couple with each other, such as in accordance with one or more communication protocols compliant with one or more communication standards. Reference to “any two devices” does not mean that only two devices may be configured to communicatively couple with each other; rather, any two devices is inclusive of more than two devices. For example, a first device may communicatively couple with a second device and the first device may communicatively couple with a third device. In such an example, the first device may be a server.

With reference to FIG. 1, the source device 102 may be described as being communicatively coupled to the destination device 104. In some examples, the term “communicatively coupled” may refer to a communication connection, which may be direct or indirect. The link 134 may, in some examples, represent a communication coupling between the source device 102 and the destination device 104. A communication connection may be wired and/or wireless. A wired connection may refer to a conductive path, a trace, or a physical medium (excluding wireless physical mediums) over which information may travel. A conductive path may refer to any conductor of any length, such as a conductive pad, a conductive via, a conductive plane, a conductive trace, or any conductive medium. A direct communication connection may refer to a connection in which no intermediary component resides between the two communicatively coupled components. An indirect communication connection may refer to a connection in which at least one intermediary component resides between the two communicatively coupled components. Two devices that are communicatively coupled may communicate with each other over one or more different types of networks (e.g., a wireless network and/or a wired network) in accordance with one or more communication protocols. In some examples, two devices that are communicatively coupled may associate with one another through an association process. In other examples, two devices that are communicatively coupled may communicate with each other without engaging in an association process. For example, a device, such as the source device 102, may be configured to unicast, broadcast, multicast, or otherwise transmit information (e.g., encoded content) to one or more other devices (e.g., one or more destination devices, which includes the destination device 104). The destination device 104 in this example may be described as being communicatively coupled with each of the one or more other devices. In some examples, a communication connection may enable the transmission and/or receipt of information. For example, a first device communicatively coupled to a second device may be configured to transmit information to the second device and/or receive information from the second device in accordance with the techniques of this disclosure. Similarly, the second device in this example may be configured to transmit information to the first device and/or receive information from the first device in accordance with the techniques of this disclosure. In some examples, the term “communicatively coupled” may refer to a temporary, intermittent, or permanent communication connection.

Any device described herein, such as the source device 102 and the destination device 104, may be configured to operate in accordance with one or more communication protocols. For example, the source device 102 may be configured to communicate with (e.g., receive information from and/or transmit information to) the destination device 104 using one or more communication protocols. In such an example, the source device 102 may be described as communicating with the destination device 104 over a connection. The connection may be compliant or otherwise be in accordance with a communication protocol. Similarly, the destination device 104 may be configured to communicate with (e.g., receive information from and/or transmit information to) the source device 102 using one or more communication protocols. In such an example, the destination device 104 may be described as communicating with the source device 102 over a connection. The connection may be compliant or otherwise be in accordance with a communication protocol.

As used herein, the term “communication protocol” may refer to any communication protocol, such as a communication protocol compliant with a communication standard or the like. As used herein, the term “communication standard” may include any communication standard, such as a wireless communication standard and/or a wired communication standard. A wireless communication standard may correspond to a wireless network. As an example, a communication standard may include any wireless communication standard corresponding to a wireless personal area network (WPAN) standard, such as Bluetooth (e.g., IEEE 802.15), Bluetooth low energy (BLE) (e.g., IEEE 802.15.4). As another example, a communication standard may include any wireless communication standard corresponding to a wireless local area network (WLAN) standard, such as WI-FI (e.g., any 802.11 standard, such as 802.11a, 802.11b, 802.11c, 802.11n, or 802.11ax). As another example, a communication standard may include any wireless communication standard corresponding to a wireless wide area network (WWAN) standard, such as 3G, 4G, 4G LTE, or 5G.

With reference to FIG. 1, the content encoder 108 may be configured to encode video or graphical content. In some examples, the content encoder 108 may be configured to encode video or graphical content as one or more video frames. When the content encoder 108 encodes content, the content encoder 108 may generate a bitstream. The bitstream may have a bit rate, such as bits/time unit, where time unit is any time unit, such as second or minute. The bitstream may include a sequence of bits that form a coded representation of the video or graphical content and associated data. To generate the bitstream, the content encoder 108 may be configured to perform encoding operations on pixel data, such as pixel data corresponding to a shaded texture atlas. For example, when the content encoder 108 performs encoding operations on image data (e.g., one or more blocks of a shaded texture atlas) provided as input to the content encoder 108, the content encoder 108 may generate a series of coded images and associated data. The associated data may include a set of coding parameters such as a quantization parameter (QP).

The mobile gaming market is one of the most important markets in the mobile world. In this market, users care greatly about the game performance. A variety of factors can be performance indicators for the mobile gaming market. For instance, frames per second (FPS) and janks, i.e., delays or pauses in frame rendering or composition, are important key performance indicators (KPI) in this market. In some aspects, a jank can be a perceptible pause in the rendering of a software application's user interface. Both FPS and janks are KPIs in game performance and/or device display capability. In mobile gaming applications, janks can be the result of a number of factors, such as slow operations or poor interface design. In some instances, a jank can also correspond to a change in the refresh rate of the display at the device. Janks are important to mobile gaming because if the display fresh latency is not stable, this can impact the user experience. Accordingly, some aspects of the mobile gaming industry are focused on reducing janks and increasing FPS.

In the mobile gaming industry, games can be run at a variety of different FPS modes. In some aspects, games can run at 30 FPS mode. In other aspects, games can run at different FPS modes, e.g., 20 or 60 FPS. Aspects of the present disclosure can include a current frame latency time, which can refer to the time difference between when a previous frame completes rendering a current frame completes rendering. The frame latency time can also refer to the time between successive refreshing frames. The frame latency time can also be based on a frame rate. In some aspects, when a gaming application runs at 30 FPS mode, although the average frame rate may be around 30 FPS, the frame latency time may not be stable. For instance, the frame latency time for each frame can be 33.33 ms (e.g., corresponding to 30 FPS), 16.67 ms (e.g., corresponding to 60 FPS), or 50 ms (e.g., corresponding to 20 FPS). Aspects of the present disclosure can provide a stable frame latency, in addition to a stable FPS and other advantages mentioned herein.

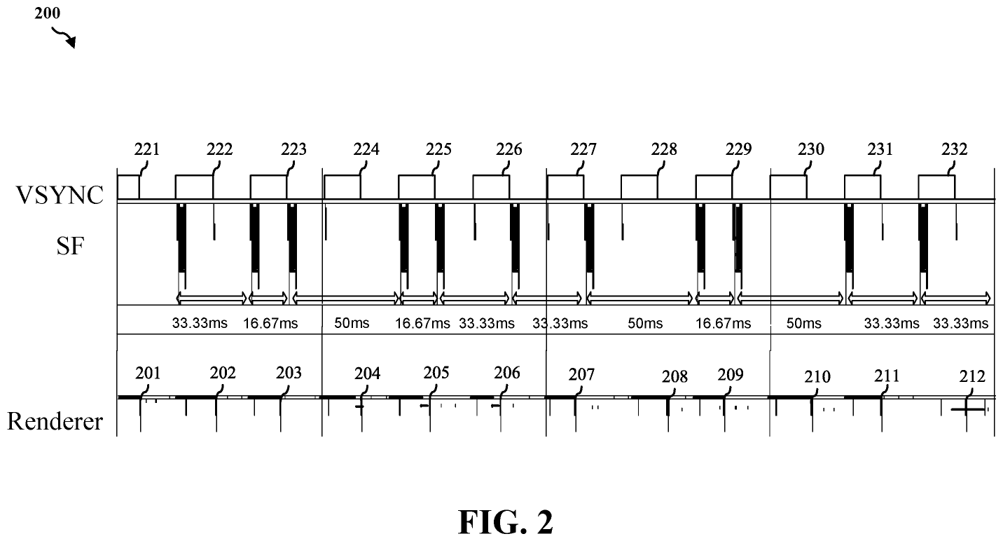

FIG. 2 illustrates an example timing diagram 200 in accordance with one or more techniques of the present disclosure. As shown in FIG. 2, timing diagram 200 includes first frame 201, second frame 202, third frame 203, fourth frame 204, fifth frame 205, sixth frame 206, seventh frame 207, eighth frame 208, ninth frame 209, tenth frame 210, eleventh frame 211, twelfth frame 212, first VSYNC time 221, second VSYNC time 222, third VSYNC time 223, fourth VSYNC time 224, fifth VSYNC time 225, sixth VSYNC time 226, seventh VSYNC time 227, eighth VSYNC time 228, ninth VSYNC time 229, tenth VSYNC time 230, eleventh VSYNC time 231, and twelfth VSYNC time 232. FIG. 2 also displays a renderer, a surface flinger (SF) mechanism, and a VSYNC timing mechanism. In some instances, the timing diagram can include a display or display engine that can also be referred to as a display buffer.

As mentioned supra, gaming applications can be run at a variety of different FPS modes. For example, in some gaming applications, a common FPS mode can be 30 FPS. Additionally, in some aspects, the frame latency time for each frame can be inconsistent. FIG. 2 illustrates timing diagram 200 for frames in a gaming application with an inconsistent frame latency time for each frame. More specifically, FIG. 2 displays that the frame latency time for each of frames 201-212 can be 16.67 ms, 33.33 ms, or 50 ms. As mentioned herein, this inconsistent frame latency time for successive frames can lead to a number of unwanted side effects, e.g., janks.

If the frame latency time between two successive frames is not stable, this can greatly impact the user experience. For example, an inconsistent frame latency time between successive frames can lead to a jank. As mentioned previously, the present disclosure can provide a stable frame latency time for each successive frame. For instance, the present disclosure seeks to prevent the frame latency time from moving inconsistently to different values between different frames. In some aspects, the frame latency time can directly correspond to the FPS mode of a gaming application. For instance, the frame latency time can be the inverse value of the FPS mode. For example, as mentioned above, a frame latency time of 50 ms corresponds to an FPS of 20. A frame latency time of 33.33 ms corresponds to an FPS of 30. Also, a frame latency time of 16.67 ms corresponds to an FPS of 60. In some instances, if the average FPS mode is 30 FPS, the average frame latency time should be 33.33 ms. As such, in aspects with a 30 FPS mode, the present disclosure may prefer a frame latency time of 33.33 ms for each frame.

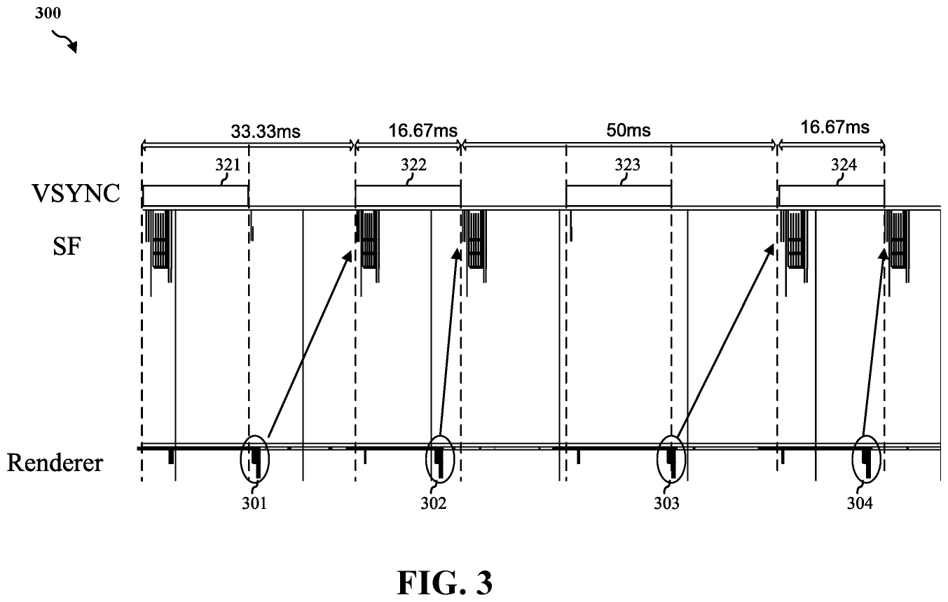

FIG. 3 illustrates an example timing diagram 300 in accordance with one or more techniques of the present disclosure. As shown in FIG. 3, timing diagram 300 includes first frame 301, second frame 302, third frame 303, fourth frame 304, first VSYNC time 321, second VSYNC time 322, third VSYNC time 323, and fourth VSYNC time 324. FIG. 3 also displays a renderer, a SF mechanism, a display or display engine, and a VSYNC timing mechanism. Like FIG. 2 above, FIG. 3 also displays that the frame latency time for successive frames, e.g., frames 301-304, in a gaming application can be inconsistent, such as 16.67 ms, 33.33 ms, or 50 ms. FIG. 3 also shows one example of frames missing a designated VSYNC timing. As shown in FIG. 3, frames 301 and 303 missed their designated VSYNC time. For instance, in some aspects, the frame renderer may follows its own rendering timeline that may not line up with the designated VSYNC timing. Accordingly, some rendered frames may not follow the VSYNC timing. As mentioned above, different frames can have a different FPS or frame latency time, e.g., based on a timeline mismatch between a frame rendering time and designated VSYNC time. Therefore, fast frames (e.g., with a low frame latency time) and slow frames (e.g., with a high frame latency time) may alternate or successively occur. In these instances, a frame rendering time or a triggered timestamp of an eglSwapBuffer mechanism in the present disclosure may not align with the designated VSYNC time for the frame.

As mentioned above, aspects of the present disclosure may prefer a stable frame latency time, which can reduce the amount of janks experienced. For example, in a gaming application with a 30 FPS mode, the present disclosure may prefer a corresponding frame latency time of 33.33 ms. In some aspects, the present disclosure can delay consuming a fast frame with a low frame latency. For instance, by delaying the consumption of frames with a relatively low frame latency, or accelerating the consumption of frames with a relatively high frame latency, the present disclosure can achieve a more consistent frame latency time or FPS for each frame. Accordingly, by achieving a constant frame latency time, the amount of janks experienced can be reduced.

In order to achieve the aforementioned consistent frame latency time, the present disclosure can detect the frames with a low frame latency, e.g., fast frames or high FPS frames, or frames with a high frame latency, e.g., slow frames or low FPS frames. In some aspects, if a fast frame is detected, the present disclosure can delay consuming or refreshing a frame until the next VSYNC time or cycle. Indeed, the present disclosure can delay the consumption of a fast frame to the next VSYNC time in order to maintain a consistent frame latency time for all frames. For example, a frame with a frame latency time of 16.67 ms can be delayed to the next VSYNC time in order to make all frames have the same latency, e.g., a 33.33 ms frame latency time.

Some aspects of the present disclosure can provide a stable frame rate in gaming applications in certain FPS modes, e.g., 20 FPS mode, 30 FPS mode, or 60 FPS mode. In order to do so, the present disclosure can utilize a number of different monitors or mechanisms, such as an FPS monitor, a buffer queue monitor, a composition refresh monitor, a frame skip monitor, an SF mechanism, and/or an SF composition monitor. As a result of these monitors or mechanisms, the user gaming experience can be greatly improved. The present disclosure can also include components to detect the frame latency time, frame refresh rates, and/or FPS mode. In some aspects, there may more than one frame in the BufferQueue or buffer queue. If this happens, the present disclosure can detect this and consume the frame in the buffer queue at the next available VSYNC time. In some aspects, if the maximum allowed frames in the buffer queue is set to one frame, then once the buffer queue reaches a value of two frames, each successive frame can be sent to the display buffer at the next VSYNC time. This can occur even if each successive frame has a frame latency time lower than the preferred or target frame latency time. This can help reduce the buffer queue accumulation of frames, which can also lead to a more consistent frame latency time between successive frames.

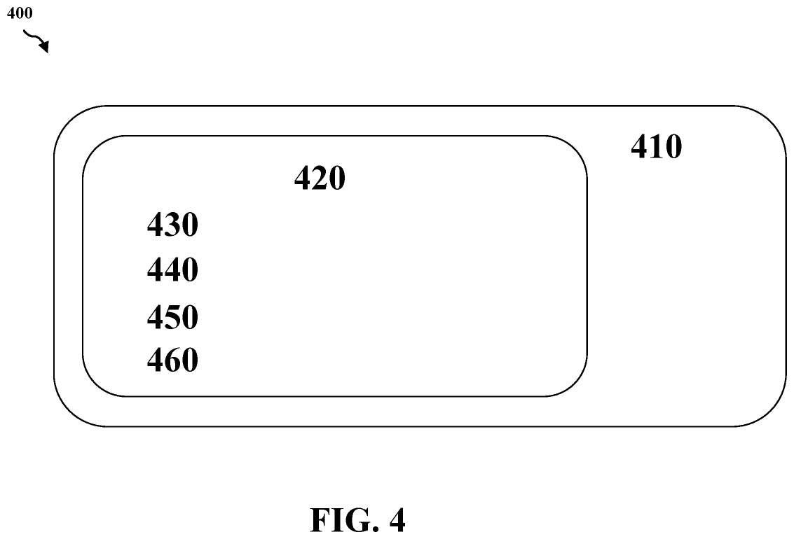

FIG. 4 illustrates an example structure 400 according to the present disclosure. More specifically, FIG. 4 displays one example structure of a SurfaceFlinger or SF mechanism 410 in the present disclosure. As displayed in FIG. 4, the SurfaceFlinger or SF mechanism 410 in the present disclosure can include a number of different mechanisms or algorithms. For instance, as shown in FIG. 4, SurfaceFlinger or SF mechanism 410 can include, e.g., an onMessageReceived mechanism 420, a bufferQueueMonitor 430, a skipMonitor 440, a refreshMonitor 450, and an FPSMonitor 460. SurfaceFlinger or SF mechanism 410 can also include a dequeueBufferMonitor, SurfaceFlinger:onMessageReceived mechanism, a BufferLayer:onFrameAvailable mechanism, and/or a bufferLayerConsumer::onDequeueBufferMonitor.

As mentioned above, the present disclosure can include a buffer queue monitor or bufferQueueMonitor. The buffer queue monitor can provide a number of different functions, such as monitoring the number of frames in the buffer queue. In some aspects, the amount of frames in the buffer queue may be set to a maximum number of frames, e.g., one or two frames. In some aspects, if the number of frames in the buffer queue is greater than one, then the frame may be consumed at the next VSYNC time. This can occur even if the frame has a low frame latency time. As such, some fast frames may not be delayed if the number of frames in the buffer queue is greater than one. For instance, if the maximum quantity of frames in the buffer queue is greater than one, a skip flag mechanism may be set to false. Otherwise, the skip flag mechanism may be set to true.

In some aspects, once a frame is rendered and ready to be sent to the buffer queue, the amount of frames in the buffer queue can be increased. Therefore, once a frame completes rendering, the frame can be sent to a buffer queue, and the buffer queue amount will be increased by one frame. In some aspects, if the amount of frames in the buffer queue is one or zero, then the frame can be consumed at the scheduled VSYNC time, e.g., if the frame has a low frame latency then it may be delayed by one VSYNC time. However, if the amount of frames in the buffer queue is two or more, the frame can then be consumed at the next VSYNC time regardless of the frame latency of the frame. For instance, if the current frame is determined to be a fast frame with a low latency, then the frame can be consumed at the next VSYNC time, so the frame consumption may not be delayed.

The present disclosure can also include a skip monitor or skipMonitor which can provide a number of different functions. For instance, when the present disclosure sets condition to a certain value, the skip monitor can skip the frame consumption to the next VSYNC time. For example, in 30 FPS mode, if a layers status is not changed, and a SocId check is supported, then the skip flag can be set, which can result in the frame consumption being delayed by one VSYNC time. Further, if a frame has a low latency value, i.e., the difference between the current timestamp and last refresh timestamp is low, e.g., 16.67 ms, then the present disclosure may delay the consumption of this frame to next VSYNC time. As further shown in FIG. 4, the present disclosure can also include a refresh monitor or refreshMonitor that can mark the refresh timestamp of each frame.

In some aspects, the present disclosure can include an FPS monitor or fpsMonitor that can perform a number of different functions. In some aspects, the fpsMonitor can also determine the FPS mode at which the game application is running. For example, if the present disclosure can detect the FPS, then the fpsMonitor may be enabled. Additionally, the fpsMonitor can also detect the latency of frames, which can help to delay frame consumption if a certain frame has a low frame latency. For example, the SF refresh timestamp may be delivered to the FPS monitor to calculate the FPS of a frame. Accordingly, the FPS monitor can detect the FPS value of each frame. As the fpsMonitor can detect the FPS mode of the game, if each frame has a latency time of 16.67 ms, then the frames will not be delayed by one VSYNC time because the fpsMonitor detects that they should have a latency of 16.67 ms. As such, the frame consumption may only be delayed for fast frames, e.g., frames with a latency of 16.67 ms, if the fpsMonitor determines that each frame should have a latency of 33.33 ms or 50 ms.

The FPS monitor or fpsMonitor can also monitor the SurfaceFlinger or SF refresh rate at certain time periods, e.g., once every second. In other aspects, the FPS monitor can detect or set the FPS mode of the gaming application, e.g., 20, 30, or 60 FPS. As such, the FPS monitor can detect that a game is running at 30 FPS mode. In some aspects, once the FPS monitor detects the variation in the refresh rate, then other aspects of the present disclosure can be applied. Hence, FPS monitors of the present disclosure can compare the frame timestamps of successive frames. In some instances, if the game suddenly changes the frame rate target, e.g., from 30 FPS to 60 FPS, then the present disclosure may understand that the game is running at a different target frame rate through the FPS monitor. In these instances, the optimization feature can be disabled. When the game runs at 30 FPS again, then the feature can be enabled again. Additionally, the FPS monitor will be reset when a large jank occurs. In some aspects, if the frame rate of each rendered frame is consistently below the FPS mode, then there may be fewer janks. In these cases, the FPS monitor may be disabled, as it may not be needed to reduce janks. For example, if the FPS mode is set to 30 FPS, such that the frame latency time should be 33.33 ms for each frame, but the frame latency time of each frame is consistently at 50 ms, then there may be no janks, so the FPS monitor may be disabled. However, if the frame rate of each frame is consistently faster than the FPS mode, or the frame latency time is consistently lower than expected latency time, then the FPS monitor can be enabled again.

The present disclosure can also include a dequeueBufferMonitor which can monitor the de-queue latency of frames in the buffer queue. For example, in 30 FPS mode, the dequeueBufferMonitor can monitor the rate or latency at which frames exit the buffer queue. In some aspects, the dequeueBufferMonitor can monitor frames exiting the buffer queue for a certain time period, e.g., once every second. If the latency of frames exiting the buffer queue is longer than a certain threshold, e.g., 11 ms, the dequeueBufferMonitor may recommend that the present disclosure stay at the current FPS mode, e.g., 30 FPS mode. The dequeueBufferMonitor can also monitor whether a user changes the FPS setting from 30 FPS to different frame rate. Further, if the dequeueBufferMonitor detects the present disclosure should not be in a certain FPS mode, e.g., 30 FPS mode, it can recommend moving to a different FPS mode, e.g., 60 FPS.

The present disclosure can also include a SurfaceFlinger:onMessageReceived mechanism which can mark a triggered timestamp of each frame or when each frame completes rendering. In some instances, the SurfaceFlinger:onMessageReceived mechanism can mark the triggered timestamp under certain conditions, e.g., the game is in a 30 FPS mode, certain layers are not changed, and/or a SocId check is supported. Additionally, if the frame latency time or the time difference between two successive frame timestamps is less than a certain time, e.g., 16.67 ms, the SurfaceFlinger:onMessageReceived may recommend to delay the consumption of the frame to next VSYNC time or cycle. In these instance, when the frame refresh occurs, the fpsMonitor can be triggered.

The present disclosure can also include a BufferLayer:onFrameAvailable mechanism. The BufferLayer:onFrameAvailable mechanism can include a SocId check mechanism, which can perform a filtering function. The BufferLayer:onFrameAvailable mechanism can also include a layers status monitor, which can monitor the name or number of different layers. In some aspects, if there is no change in status of the current layers, then the related flag can be identified, e.g., a flag identifying that layers are not changed. The present disclosure can also include a bufferLayerConsumer::onDequeueBufferMonitor which can communicate with the dequeueBufferMonitor or identify if the dequeueBufferMonitor is functioning.

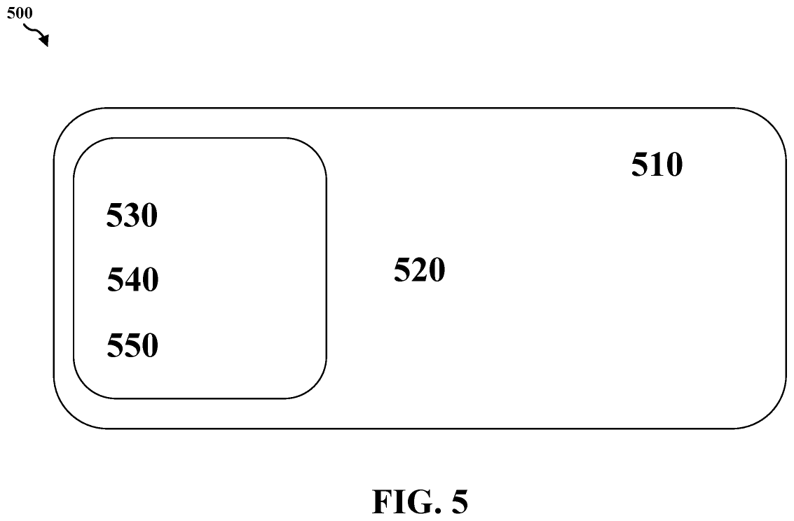

FIG. 5 illustrates another example layout 500 according to the present disclosure. More specifically, FIG. 5 displays one example structure of a binder thread mechanism 510 in the present disclosure. As displayed in FIG. 5, the binder thread mechanism 510 in the present disclosure can include a number of different mechanisms or algorithms. For instance, as shown in FIG. 5, binder thread mechanism 510 can include, e.g., buffer queue or queueBuffer 520, onFrameAvailable mechanism 530, SocId check 540, and layer status check 550. As mentioned above, the buffer queue 520 can include a number of frames. In some aspects, onFrameAvailable mechanism 530 can detect if a layer status has changed. For example, onFrameAvailable mechanism 530 can help to move to a different FPS mode, if necessary. In one aspect of the present disclosure, SocId check 540 can perform a filtering function. In some aspects, certain mechanisms may only be supported on certain types of chipsets, so the present disclosure can utilize a SocId check 540 to filter them. In some aspects, the layer status check 550 can monitor the status of layers. For example, the layer status check 550 can monitor the name, size, and/or number or layers. If the layers status change, then the related flag may be set. Additionally, binder thread mechanism 510 can include a switch frame rate setting which can be activated in a game that can switch the frame rate, e.g., from 30 FPS to 40 FPS.

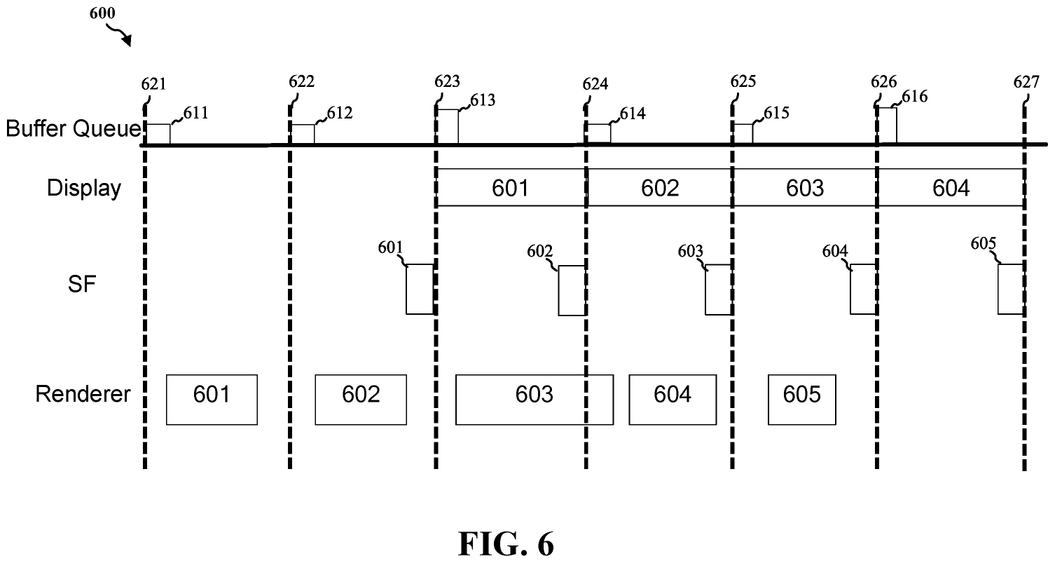

FIG. 6 illustrates an example timing diagram 600 in accordance with one or more techniques of this disclosure. As shown in FIG. 6, timing diagram 600 includes first frame 601, second frame 602, third frame 603, fourth frame 604, fifth frame 605, buffer queue status 611, buffer queue status 612, buffer queue status 613, buffer queue status 614, buffer queue status 615, buffer queue status 616, first VSYNC time 621, second VSYNC time 622, third VSYNC time 623, fourth VSYNC time 624, fifth VSYNC time 625, sixth VSYNC time 626, and seventh VSYNC time 627. FIG. 6 also displays a renderer, a surface flinger (SF) mechanism, a display or display engine, and a buffer queue. The display or display engine can also be referred to as a display buffer.

Buffer queue status 611-616 can include the amount of frames that are currently in the buffer queue. For example, buffer queue status 611 can have a value of one, as there is currently one frame in the buffer queue at that time. Additionally, buffer queue status 612 can have a value of one, buffer queue status 613 can have a value of two, buffer queue status 614 can have a value of one, buffer queue status 615 can have a value of one, and buffer queue status 616 can have a value of two. As shown in FIG. 6, if a buffer queue status has a higher value, it is shown as being taller than a buffer queue status with a lower value. Accordingly, buffer queue status 613 and 616 appear taller in FIG. 6 than buffer queue status 611, 612, 614, and 615.

As indicated previously, the present disclosure may determine a target frame latency time. The present disclosure can also determine whether a current frame latency time of a current frame is less than the target frame latency time. For instance, with reference to FIG. 6, the present disclosure can determine whether the frame latency times for frames 601-605 is less than the target frame latency time. For example, if the target frame latency time is 33.33 ms, then the present disclosure can determine whether the frame latency times for frames 601-605 is less than 33.33 ms. The present disclosure can also consume a current frame at a first VSYNC time if the current frame latency time is greater than or equal to the target frame latency time. In some aspects, for a current frame, the first VSYNC time can be the VSYNC time after the frame completes rendering. For example, the SF mechanism can consume frames 601-605 at the VSYNC time after frames 601-605 complete rendering, e.g., VSYNC times 622-626, respectively, if the frame latency times for frames 601-605 is greater than or equal to the target frame latency time, e.g., 33.33 ms. In one aspect, the frame latency times for frames 601, 602, 603, 604, and 605 can be 16.67 ms, 16.67 ms, 33.33 ms, 16.67 ms, and 16.67 ms, respectively. In this aspect, the SF mechanism can consume frame 603 at the VSYNC time after frame 603 completes rendering, e.g., VSYNC time 625, as it may have a frame latency time greater than or equal to the target frame latency time, e.g., 33.33 ms.

The present disclosure can also determine the amount of frames in a buffer queue if the current frame latency time is less than the target frame latency time. In one aspect, the frame latency times for frames 601, 602, 604, and 605 can be 16.67 ms, 16.67 ms, 16.67 ms, and 16.67 ms, respectively, and the target frame latency time can be 33.33 ms. In this aspect, the present disclosure can determine that the frame latency times for frames 601, 602, 604, and 605 is less than the target frame latency time. The present disclosure can also determine whether the amount of frames in the buffer queue is greater than one. For example, the present disclosure can determine that the amount of frames in the buffer queue, e.g., buffer queue status 613 and 616, can be greater than equal to one.

The present disclosure can also consume the current frame at the first VSYNC time if the amount of frames in the buffer queue is greater than one. For instance, SF mechanism can consume frames 601-605 at the VSYNC time after frames 601-605 complete rendering, e.g., VSYNC times 622-626, respectively, if the amount of frames in the buffer queue, e.g., buffer queue status 611-615, is greater than one. In one instance, as shown in FIG. 6, buffer status 613 is greater than one, so SF mechanism consumes frame 603 at VSYNC time 625. Additionally, the present disclosure can consume the current frame at a second VSYNC time if the amount of frames in the buffer queue is less than or equal to one, where the second VSYNC time is after the first VSYNC time. In some aspects, for a current frame, the second VSYNC time can be the second VSYNC time after the frame completes rendering. For example, as shown in FIG. 6, the buffer queue status 611, 612, 614, and 615 is one, so frames 601, 602, 604, and 605 can be consumed at VSYNC times 623, 624, 626, and 627, respectively.

In some aspects, the current frame latency time can be the difference between a previous frame rendering completion time and a current frame rendering completion time. For instance, a previous frame can complete rendering at the previous frame rendering completion time and a current frame can complete rendering at the current frame rendering completion time. In some instances, the current frame latency time can also be based on a current frame rate of the current frame. As mentioned above, a SF mechanism may consume the frame at the first VSYNC time. For example, as shown in FIG. 6, SF mechanism consumes frame 603 at VSYNC time 625.

In addition, when the SF mechanism consumes the current frame at the first VSYNC time, the present disclosure can send the current frame to the buffer queue at the first VSYNC time. For example, as shown in FIG. 6, when the SF mechanism consumes frame 603 at VSYNC time 625, frame 603 can be sent to the buffer queue. In some aspects, the apparatus can send the current frame from the buffer queue to a display buffer. Additionally, the apparatus can increase the amount of frames in the buffer queue if the current frame latency time is less than the target frame latency time. For instance, as shown in FIG. 6, buffer queue status 613 can be increased to a value of two if frame 602 has a frame latency time of 16.67 ms, i.e., less than the target frame latency time of 33.33 ms. Additionally, as shown in FIG. 6, buffer queue status 616 can be increased to a value of two if frame 605 has a frame latency time of 16.67 ms, i.e., less than the target frame latency time of 33.33 ms.

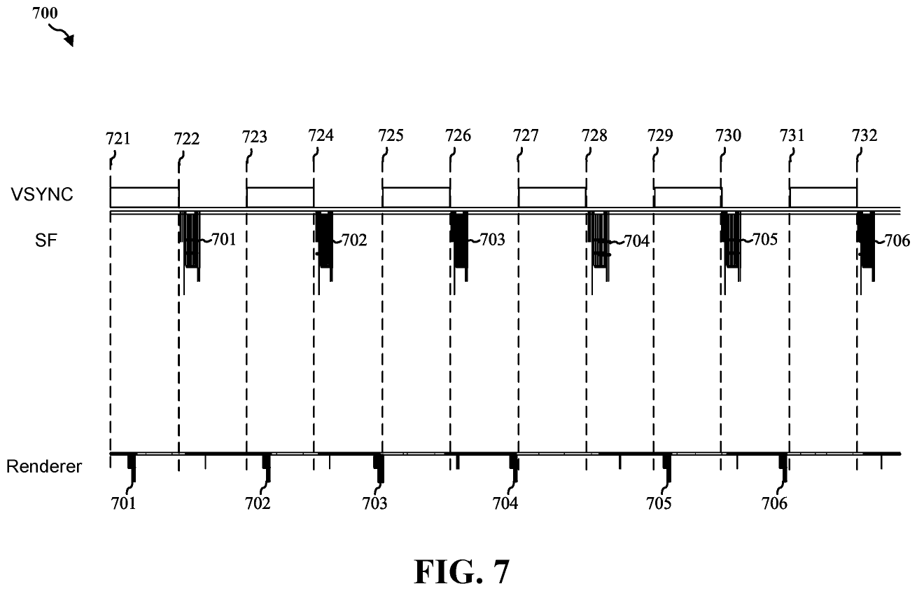

FIG. 7 illustrates an example timing diagram 700 according to the present disclosure. As shown in FIG. 7, timing diagram 700 includes first frame 701, second frame 702, third frame 703, fourth frame 704, fifth frame 705, sixth frame 706, first VSYNC time 721, second VSYNC time 722, third VSYNC time 723, fourth VSYNC time 724, fifth VSYNC time 725, sixth VSYNC time 726, seventh VSYNC time 727, eighth VSYNC time 728, ninth VSYNC time 729, tenth VSYNC time 730, eleventh VSYNC time 731, and twelfth VSYNC time 732. FIG. 6 also displays a renderer, a SF mechanism, and a VSYNC mechanism. Timing diagram 700 shows that frames with a low latency time or a fast rate can be delayed a VSYNC cycle. For example, frames 703, 704, and 706 have a fast rate and have a low latency time, so they are delayed one VSYNC cycle to VSYNC times 726, 728, 732, respectively.

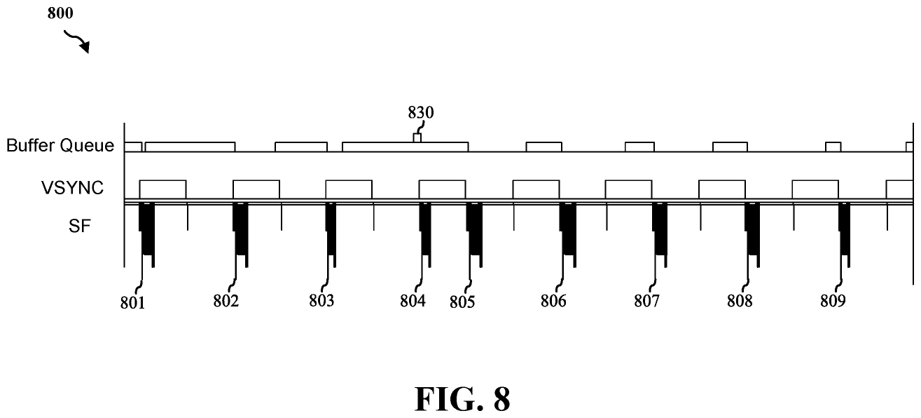

FIG. 8 illustrates another example timing diagram 800 according to the present disclosure. As shown in FIG. 8, timing diagram 800 includes first frame 801, second frame 802, third frame 803, fourth frame 804, fifth frame 805, sixth frame 806, seventh frame 807, eighth frame 808, ninth frame 809, and buffer queue status 830. Timing diagram 800 shows that if the buffer queue status 830 indicates that more than one frame is in the buffer queue, then even if the frame has a low latency time, it may not be delayed a VSYNC cycle. For instance, as shown in FIG. 8, buffer queue status 830 has a value of two, which indicates that there are two frames in the buffer queue. Accordingly, the next rendered frame, e.g., frame 805, may be consumed at the next VSYNC time, even if the frame has a low latency time. For instance, in some aspects, if the buffer queue status 830 has a value of more than one, e.g., two or more, then a skip VSYNC monitor or flag may be set to false. As such, the frame will be consumed at the next VSYNC cycle, even if the frame has a low latency time. In some aspects, if the buffer queue is set at a maximum quantity of one, then the skip VSYNC monitor or flag may be set to true, and the frame will be delayed by one VSYNC cycle.

As mentioned previously, aspects of the present disclosure can achieve a significant reduction in janks for gaming applications. In one example gaming application, the present disclosure can achieve a 65% reduction in janks when utilizing the mechanisms described herein. In other gaming applications, the present disclosure can achieve a 73% reduction in janks. In yet other gaming applications, the present disclosure can achieve a 97% or 98% reduction in janks. Additionally, the present disclosure can help gaming applications to achieve a desired FPS mode. In some aspects, the present disclosure can assist gaming applications in achieving a 30 FPS mode. For example, if the desired FPS mode is 30, the present disclosure may help achieve an average FPS of 29.86.

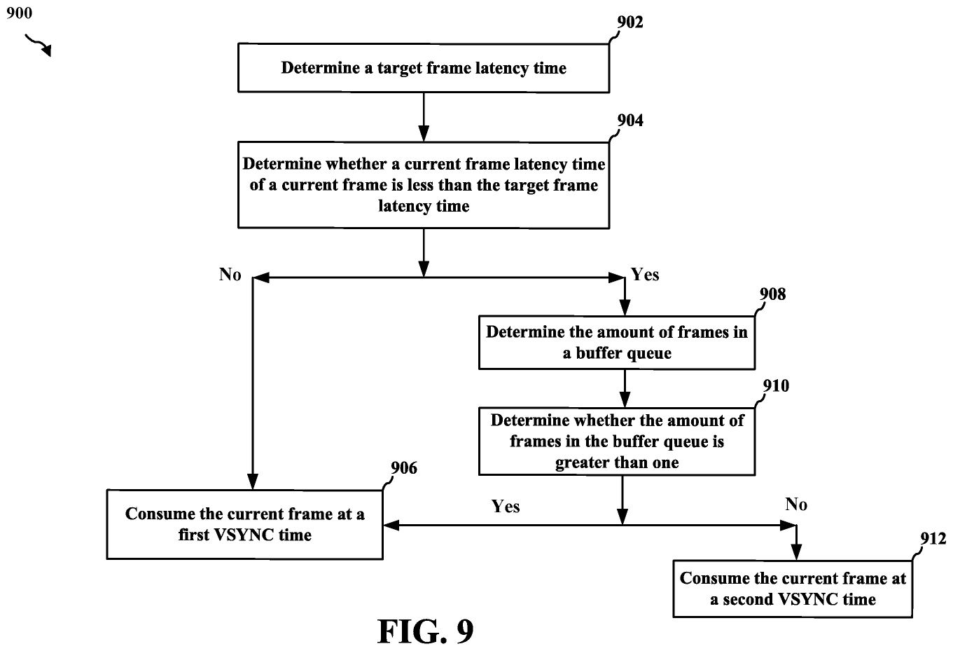

FIG. 9 illustrates an example flowchart 900 of an example method in accordance with one or more techniques of this disclosure. The method may be performed by a frame composer, GPU, or apparatus for frame or graphics processing. At 902, the apparatus may determine a target frame latency time, as described in connection with the examples in FIGS. 4-8. At 904, the apparatus may determine whether a current frame latency time of a current frame is less than the target frame latency time, as described in connection with the examples in FIGS. 4-8. At 906, the apparatus can consume the current frame at a first VSYNC time if the current frame latency time is greater than or equal to the target frame latency time, as described in connection with the examples in FIGS. 4-8. At 908, the apparatus can determine the amount of frames in a buffer queue if the current frame latency time is less than the target frame latency time, as described in connection with the examples in FIGS. 4-8. At 910, the apparatus can determine whether the amount of frames in the buffer queue is greater than one, as described in connection with the examples in FIGS. 4-8.

Additionally, at 906, the apparatus can consume the current frame at the first VSYNC time if the amount of frames in the buffer queue is greater than one, as described in connection with the examples in FIGS. 4-8. At 912, the apparatus can consume the current frame at a second VSYNC time if the amount of frames in the buffer queue is less than or equal to one, where the second VSYNC time is after the first VSYNC time, as described in connection with the examples in FIGS. 4-8.

Additionally, the current frame latency time can be the difference between a previous frame rendering completion time and a current frame rendering completion time, where a previous frame completes rendering at the previous frame rendering completion time and the current frame completes rendering at the current frame rendering completion time, as described in connection with the examples in FIGS. 4-8. The current frame latency time can also be based on a current frame rate of the current frame, as described in connection with the examples in FIGS. 4-8. In some aspects, a surface flinger (SF) mechanism may consume the frame at the first VSYNC time, as described in connection with the examples in FIGS. 4-8.

In addition, when the apparatus consumes the current frame at the first VSYNC time, the apparatus can send the current frame to the buffer queue at the first VSYNC time, as described in connection with the examples in FIGS. 4-8. In some aspects, the apparatus can send the current frame from the buffer queue to a display buffer, as described in connection with the examples in FIGS. 4-8. Additionally, the apparatus can increase the amount of frames in the buffer queue if the current frame latency time is less than the target frame latency time, as described in connection with the examples in FIGS. 4-8.

In one configuration, a method or apparatus for operation of a frame composer is provided. The apparatus may be a frame composer, a GPU, or some other processor in frame or graphics processing. In one aspect, the apparatus may be the processing unit 120 within the device 104, the processing unit 106 within the device 102, or may be some other hardware within devices 102/104 or another device. The apparatus may include means for determining a target frame latency time. The apparatus can also include means for determining whether a current frame latency time of a current frame is less than the target frame latency time. Further, the apparatus can include means for consuming the current frame at a first VSYNC time if the current frame latency time is greater than or equal to the target frame latency time. The apparatus can also include means for determining the amount of frames in a buffer queue if the current frame latency time is less than the target frame latency time. The apparatus can also include means for determining whether the amount of frames in the buffer queue is greater than one. Additionally, the apparatus can include means for consuming the current frame at the first VSYNC time if the amount of frames in the buffer queue is greater than one. Also, the apparatus can include means for consuming the current frame at a second VSYNC time if the amount of frames in the buffer queue is less than or equal to one, where the second VSYNC time is after the first VSYNC time. In some aspects, the means for consuming the current frame at the first VSYNC time can comprise means for sending the current frame to the buffer queue at the first VSYNC time. The apparatus can also include means for increasing the amount of frames in the buffer queue if the current frame latency time is less than the target frame latency time.

The subject matter described herein can be implemented to realize one or more benefits or advantages. For instance, the described frame or graphics processing techniques can be used by frame composers, GPUs, or other frame or graphics processors to provide improved and dynamic janks reduction. The present disclosure can also maintain a consistent FPS rate or frame latency among rendered frames. By doing so, the present disclosure can help to reduce janks and/or provide for a smoother gaming experience. In further aspects, the present disclosure can detect potentially harmful rendering or composition scenarios dynamically in advance.

In accordance with this disclosure, the term “or” may be interrupted as “and/or” where context does not dictate otherwise. Additionally, while phrases such as “one or more” or “at least one” or the like may have been used for some features disclosed herein but not others; the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules or units are described in this disclosure to emphasize functional aspects of devices configured to perform the disclosed techniques, but do not necessarily require realization by different hardware units. Rather, as described above, various units may be combined in any hardware unit or provided by a collection of interoperative hardware units, including one or more processors as described above, in conjunction with suitable software and/or firmware.

Various examples have been described. These and other examples are within the scope of the following claims.

What is claimed is:

1. A method of operation of a frame composer, comprising:
determining a target frame latency time;
determining whether a current frame latency time of a current frame is less than the target frame latency time;
consuming the current frame at a first vertical synchronization (VSYNC) time if the current frame latency time is greater than or equal to the target frame latency time; and
determining the amount of frames in a buffer queue if the current frame latency time is less than the target frame latency time.

2. The method of claim 1, further comprising:
determining whether the amount of frames in the buffer queue is greater than one.

3. The method of claim 2, further comprising:
consuming the current frame at the first VSYNC time if the amount of frames in the buffer queue is greater than one.

4. The method of claim 2, further comprising:
consuming the current frame at a second VSYNC time if the amount of frames in the buffer queue is less than or equal to one, wherein the second VSYNC time is after the first VSYNC time.

5. The method of claim 1, wherein the current frame latency time is the difference between a previous frame rendering completion time and a current frame rendering completion time, wherein a previous frame completes rendering at the previous frame rendering completion time and the current frame completes rendering at the current frame rendering completion time.

6. The method of claim 1, wherein the current frame latency time is based on a current frame rate of the current frame.

7. The method of claim 1, wherein a surface flinger (SF) mechanism consumes the frame at the first VSYNC time.

8. The method of claim 1, wherein consuming the current frame at the first VSYNC time comprises sending the current frame to the buffer queue at the first VSYNC time.

9. The method of claim 8, further comprising:
sending the current frame from the buffer queue to a display buffer.

10. The method of claim 1, further comprising:
increasing the amount of frames in the buffer queue if the current frame latency time is less than the target frame latency time.

11. An apparatus for operation of a frame composer, comprising:
a memory; and
at least one processor coupled to the memory and configured to:
determine a target frame latency time;
determine whether a current frame latency time of a current frame is less than the target frame latency time;
consume the current frame at a first vertical synchronization (VSYNC) time if the current frame latency time is greater than or equal to the target frame latency time; and
determine the amount of frames in a buffer queue if the current frame latency time is less than the target frame latency time.

12. The apparatus of claim 11, wherein the at least one processor is further configured to:
determine whether the amount of frames in the buffer queue is greater than one.

13. The apparatus of claim 12, wherein the at least one processor is further configured to:
consume the current frame at the first VSYNC time if the amount of frames in the buffer queue is greater than one.

14. The apparatus of claim 12, wherein the at least one processor is further configured to:
consume the current frame at a second VSYNC time if the amount of frames in the buffer queue is less than or equal to one, wherein the second VSYNC time is after the first VSYNC time.

15. The apparatus of claim 11, wherein the current frame latency time is the difference between a previous frame rendering completion time and a current frame rendering completion time, wherein a previous frame completes rendering at the previous frame rendering completion time and the current frame completes rendering at the current frame rendering completion time.

16. The apparatus of claim 11, wherein the current frame latency time is based on a current frame rate of the current frame.

17. The apparatus of claim 11, wherein a surface flinger (SF) mechanism consumes the frame at the first VSYNC time.

18. The apparatus of claim 11, wherein to consume the current frame at the first VSYNC time comprises the at least one processor is configured to send the current frame to the buffer queue at the first VSYNC time.

19. The apparatus of claim 18, wherein the at least one processor is further configured to:
send the current frame from the buffer queue to a display buffer.

20. The apparatus of claim 11, wherein the at least one processor is further configured to:
increase the amount of frames in the buffer queue if the current frame latency time is less than the target frame latency time.

21. An apparatus for operation of a frame composer, comprising:
means for determining a target frame latency time;
means for determining whether a current frame latency time of a current frame is less than the target frame latency time;
means for consuming the current frame at a first vertical synchronization (VSYNC) time if the current frame latency time is greater than or equal to the target frame latency time; and
means for determining the amount of frames in a buffer queue if the current frame latency time is less than the target frame latency time.

22. The apparatus of claim 21, further comprising:
means for determining whether the amount of frames in the buffer queue is greater than one.

23. The apparatus of claim 22, further comprising:
means for consuming the current frame at the first VSYNC time if the amount of frames in the buffer queue is greater than one.

24. The apparatus of claim 22, further comprising:
means for consuming the current frame at a second VSYNC time if the amount of frames in the buffer queue is less than or equal to one, wherein the second VSYNC time is after the first VSYNC time.

25. The apparatus of claim 21, wherein the current frame latency time is the difference between a previous frame rendering completion time and a current frame rendering completion time, wherein a previous frame completes rendering at the previous frame rendering completion time and the current frame completes rendering at the current frame rendering completion time.

26. The apparatus of claim 21, wherein the current frame latency time is based on a current frame rate of the current frame.

27. The apparatus of claim 21, wherein a surface flinger (SF) mechanism consumes the frame at the first VSYNC time.

28. The apparatus of claim 21, wherein the means for consuming the current frame at the first VSYNC time comprises means for sending the current frame to the buffer queue at the first VSYNC time.

29. The apparatus of claim 21, further comprising:
means for increasing the amount of frames in the buffer queue if the current frame latency time is less than the target frame latency time.

30. A computer-readable medium storing computer executable code for operation of a frame composer, comprising code to:
determine a target frame latency time;
determine whether a current frame latency time of a current frame is less than the target frame latency time;
consume the current frame at a first vertical synchronization (VSYNC) time if the current frame latency time is greater than or equal to the target frame latency time; and
determine the amount of frames in a buffer queue if the current frame latency time is less than the target frame latency time.
